(19) United States
(12) Patent Application Publication
(10) Pub. No.: US 2026/0099329 A1
(43) Pub. Date: Apr. 9, 2026

(54) VECTOR PROCESSOR PERFORMANCE ENHANCEMENT

(71) Applicant: Microsemi SOC Corp., Chandler, AZ (US)

(72) Inventors: Arunkumar Devidas Naik, Bangalore (IN); Aaron Severance, Pender Island (CA)

(73) Assignee: Microsemi SOC Corp., Chandler, AZ (US)

(21) Appl. No.: 19/297,408

(22) Filed: Aug. 12, 2025

(30) Foreign Application Priority Data
Aug. 29, 2024 (IN) 202411065369

(51) Int. Cl. G06F 9/30

(52) U.S. Cl. CPC G06F 9/30036; G06F 9/3001; G06F 9/30065; G06F 9/30105

(57) ABSTRACT

The system may speed up reduced instruction set computing/single instruction, multiple data (RISCV/SIMD) vector processing (VP) by adding a register circuit for an additional vector register file for a total of two VRF registers. One of the VRF registers may be used for data transfers to and from memory, and the other VRF register may be used for arithmetic logic unit (ALU) operands. The VRFs may be switched alternatively to perform the data transfers and operands.

### CROSS-REFERENCE TO RELATED APPLICATIONS

This application claims priority to Indian Patent Application number 202411065369, filed Aug. 29, 2024, which is hereby incorporated by reference in its entirety for all purposes as if fully set forth herein.

### TECHNICAL FIELD

The present application relates to microprocessors and, more particularly, to generic custom instruction-set addition for reduced instruction set computing/single instruction, multiple data (RISCV/SIMD) vector processor performance enhancement.

### BACKGROUND

RISC-V is an open source instruction set architecture (ISA) for embedded systems. The addition of the vector extension (RVV) enables single instruction multiple data (SIMD) processing. This combination may allow for parallel processing of data, making it suitable for tasks like signal processing, machine learning, and other computationally intensive workloads in embedded devices. The RISC-V vector extension (RVV) may provide a flexible way to perform SIMD operations. RVV allows for vectors of varying lengths, unlike traditional fixed-length SIMD implementations, which improves flexibility and code density. SIMD allows a single instruction to operate on multiple data elements simultaneously to accelerate computationally intensive tasks.

RISC-V based microcontrollers can be integrated with various peripherals and sensors found in embedded systems.

The RISC-V register file includes a set of registers used for holding data during instruction execution. The number of registers depends on the specific RISC-V variant being used. RISC-V registers are named using a standard convention. For example, in the RV32I, there are thirty-two (32) general-purpose registers named x0 to x31. The x0 register is hardwired to zero, while the others can be used for holding data.

In addition to general-purpose registers, RISC-V architecture includes special-purpose registers, such as the program counter (PC) and various control and status registers (CSRs). These registers control processor behavior and facilitate system-level functions like exception handling and virtual memory.

One of the special-purpose registers is the Program Counter (PC), which stores the address of the next instruction to be fetched from memory. During instruction execution, the PC is incremented to point to the next instruction in memory. When a branch or jump instruction is executed, the PC is updated to point to the new target address. Control and Status Registers (CSRs) are another type of special-purpose register used for controlling the processor's behavior and reporting its status. CSRs are read and written using instructions, providing access to control and status information such as interrupt status, privilege level, and trap handling.

The arithmetic logic unit (ALU) is used for the RISC-V implementation to run the instructions, such as adding/subtracting registers, and changing branches. ALUs wait for operands/data to start computation. For SIMD/RISCV processors and vector processors, “data wait time” is a precious commodity. The cycles inside of kernel loops are expensive in terms of total cycle time for execution. For repetitive operations as in small, real-time kernel loops, data arrives from memory in batches and will consume processing cycles, which forces the ALU to wait. Likewise, to start next loop iteration that starts with load operation from memory is also stalled to complete the store operation of ALU result in the current loop iteration.

There is a need for faster processing of applications processing on central processing units, especially vector processing (VP) for embedded RISC-V applications.

### SUMMARY

According to an aspect, there is provided a vector processor system, comprising: a vector processor, in a loop iteration cycle, operable to: enable a first vector register file to perform a first role of loading vector data of a subsequent loop iteration cycle from a memory into the first vector register file; enable a second vector register file to perform a second role of providing input and output registers as operands for an arithmetic logic unit (ALU) operation using vector data of the current loop iteration cycle from the second vector register file; enable the first vector register file to further perform the first role of storing a result of an ALU operation using vector data of a prior loop iteration cycle in the first vector register file; and switch roles of the first vector register file and the second vector register file.

An aspect as in the preceding paragraph provides a vector processor system, wherein the vector processor, in the subsequent loop iteration cycle, is further operable to: enable the second vector register file to perform the first role of loading new vector data from the memory into the second vector register file while enabling the first vector register file to perform the second role of providing input and output registers as operands for a subsequent ALU operation using the vector data from the first vector register file.

An aspect as in one of the two preceding paragraph provides a vector processor system, wherein the vector processor, in the subsequent loop iteration cycle, is further operable to enable the second vector register file to further perform the first role of loading the next loop iteration's input operands using new vector data and storing a result of the previous ALU operation after switching roles of the first and second vector register files.

An aspect as in one of the three preceding paragraph provides a vector processor system, wherein switching roles of the first vector register file and the second vector register file comprises connecting the first vector register file to the memory and the second vector register file to an ALU.

An aspect as in one of the four preceding paragraph provides a vector processor system, wherein subsequently switching roles again further comprises: disconnecting the first vector register file from the memory and disconnecting the second vector register file from the ALU; and connecting the first vector register file to the ALU and the second vector register file to the memory.

An aspect as in one of the five preceding paragraph provides a vector processor system, wherein the processor is further operable to disable the second vector register file after completing a series of ALU operations over multiple loop iterations.

An aspect as in one of the six preceding paragraph provides a vector processor system, further comprising: a state machine operable to control enabling, disabling, and switching of the first and second vector register files.

According to an aspect, there is provided a method of operating a vector processor, comprising: enabling a first vector register file to perform a first role of loading vector data from a memory into the first vector register file; enabling a second vector register file to perform a second role of performing an arithmetic logic unit (ALU) operation using the vector data from the second vector register file; enabling the first vector register file to further perform the first role of storing a result of the ALU operation in the first vector register file; and switching roles of the first vector register file and the second vector register file.

An aspect as in the preceding paragraph provides a method, further comprising enabling the second vector register to perform the first role of loading new vector data from the memory into the first vector register file and storing result of a ALU result from the first register file, while enabling the second vector register file to perform the second role of providing input and output operand registers for the ALU operation.

An aspect as in one of the two preceding paragraphs provides a method, further comprising enabling the second vector register file to further providing input and output registers for a subsequent ALU operation using the new vector data from the second vector register file and storing result of ALU operation respectively after switching roles of the first and second vector register files.

An aspect as in one of the three preceding paragraphs provides a method, wherein switching roles of the first vector register file and the second vector register file comprises connecting the first vector register file to the memory and the second vector register file to the ALU.

An aspect as in one of the three preceding paragraphs provides a method, wherein switching roles further comprises: disconnecting the first vector register file from the memory and disconnecting the second vector register file from the ALU; and connecting the first vector register file to the ALU and the second vector register file to the memory.

An aspect as in one of the four preceding paragraphs provides a method, further comprising disabling the second vector register file after completing a series of ALU operations over multiple loop iterations.

An aspect as in one of the five preceding paragraphs provides a method, further comprising controlling enabling, disabling, and switching of the first and second vector register files using a state machine.

According to aspects, there is provided a non-transitory computer-readable medium storing instructions that, when executed by a processor, cause the processor to perform operations comprising: enabling a first vector register file and a second vector register file in a vector processor; alternately using the first vector register file for memory operations and the second vector register file for arithmetic logic unit (ALU) operations; and switching roles of the first vector register file and the second vector register file after completing a set of vector operations.

An aspect as in the preceding paragraph provides a non-transitory computer-readable medium storing instructions that, when executed by a processor, cause the processor to perform operations, wherein the operations further comprise loading vector data from a memory into the first vector register file while performing ALU operations using the second vector register file.

An aspect as in one of the two preceding paragraphs provides a non-transitory computer-readable medium storing instructions that, when executed by a processor, cause the processor to perform operations, wherein the operations further comprise storing results of the ALU operations in the first vector register file while performing an ALU operation using registers of the second vector register file as input and output operands.

An aspect as in one of the three preceding paragraphs provides a non-transitory computer-readable medium storing instructions that, when executed by a processor, cause the processor to perform operations, wherein switching roles of the first vector register file and the second vector register file comprises: connecting the first vector register file to an arithmetic logic unit and the second vector register file to the memory.

An aspect as in one of the four preceding paragraphs provides a non-transitory computer-readable medium storing instructions that, when executed by a processor, cause the processor to perform operations, wherein subsequently again switching roles of the first vector register file and the second vector register file comprises: disconnecting the first vector register file from the memory and disconnecting the second vector register file from the ALU; and connecting the first vector register file to the ALU and the second vector register file to a memory.

An aspect as in one of the five preceding paragraphs provides a non-transitory computer-readable medium storing instructions that, when executed by a processor, cause the processor to perform operations, wherein the operations further comprise disabling the second vector register file after completing a series of vector operations over multiple loop iterations to return to a default configuration with only the first vector register file enabled.

An aspect as in one of the six preceding paragraphs provides a non-transitory computer-readable medium storing instruction that, when executed by a processor, cause the processor to perform operations, wherein the operations further comprise copying persistent vector data stored in any vector registers used in the program (or safe vectors) that do not change or get updated as a result of an operation in the current iteration loop (i.e. persistent vector data to be retained from one iteration to the next iteration) from current ALU-connected vector register file to corresponding vector register in the memory-connected vector register file.

### BRIEF DESCRIPTION OF THE DRAWINGS

A more complete understanding of the disclosure and the advantages thereof may be acquired by referring to the following description, taken in conjunction with the accompanying drawings and wherein:

FIG. 1 may illustrate application processing on a CPU, especially vector processor (VP) for embedded RISCV applications.

FIG. 2A shows a block diagram of a vector processor base architecture, wherein memory communicates with a network via a register file and an ALU also communicates with the network.

FIG. 2B shows a block diagram of a vector processor base architecture with a custom hardware enhancement including an additional register file, wherein memory communicates with a network via a register file, and the system may switch between register file and the additional register file.

FIG. 3A shows a flow diagram to illustrate operation of a RISCV/SIMD-VP system using one vector register file for two subsequent loop iterations.

FIG. 3B shows a flow diagram illustrating operation of a RISCV/SIMD-VP system using a vector register file and an additional vector register file for two consecutive loop iterations.

FIG. 4 shows a flow chart of a method for speeding up RISCV/SIMD-VP by overcoming data and operand dependence by adding an additional circuit for an additional vector register file.

The drawings accompanying and forming part of this specification are included to depict certain aspects of the disclosure. The reference number for any illustrated element that appears in multiple different figures has the same meaning across the multiple figures, and the mention or discussion herein of any illustrated element in the context of any particular figure also applies to each other figure, if any, in which that same illustrated element is shown. The features illustrated in the drawings are not necessarily drawn to scale. It should be noted that the features illustrated in the drawings are not necessarily drawn to scale.

### DETAILED DESCRIPTION

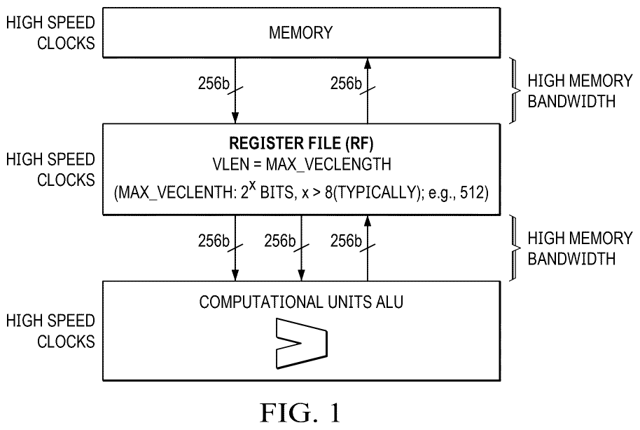

FIG. 1 is an illustration of an example processing system, according to examples of the present disclosure.

FIG. 1 may illustrate application processing on a CPU, especially vector processor (VP) for embedded RISCV applications. The system may speed up RISCV/SIMD-VP by overcoming data and operand dependence by adding an additional circuit for an additional Vector Register File (VRFA, VRFB). Vector registers in one of the VRFs may be used for data transfers to and from memory, and the vector registers in the other VRF may be used for arithmetic logic unit (ALU) operands. The VRFs may be switched alternatively to perform the data transfers and operands. The additional Vector Register File (VRFA, VRFB) may be implemented and supported with just a few custom instructions (3-4). These instructions may include support base and base plus customer vector processor instructions. The memory and CPUs may run on high speed clocks and may interface each other through high memory bandwidth connections. This may use register files.

Because the ALU waits for operands and data to start its computation, the system may speed up RISCV/SIMD-VP by overcoming data and operand dependence. This dependence may be overcome by segregating memory LOAD/STORE and ALU operands on different VRFs with one-to-one correspondence, so that the memory LOAD/STORE and ALU operands are delinked. The processor is enabled to work in “Double Buffered Memory” or “Ping-pong Memory” fashion using the two VRFs. To this end, a circuit is added for an additional Vector Register File (VRFA, VRFB).

Use cases may include all embedded real-time signal/video/CV processing kernels that depend on buffered and framed data. Applications may be made on SIMD type of vector processors with high memory bandwidth (e.g. RISCV VP).

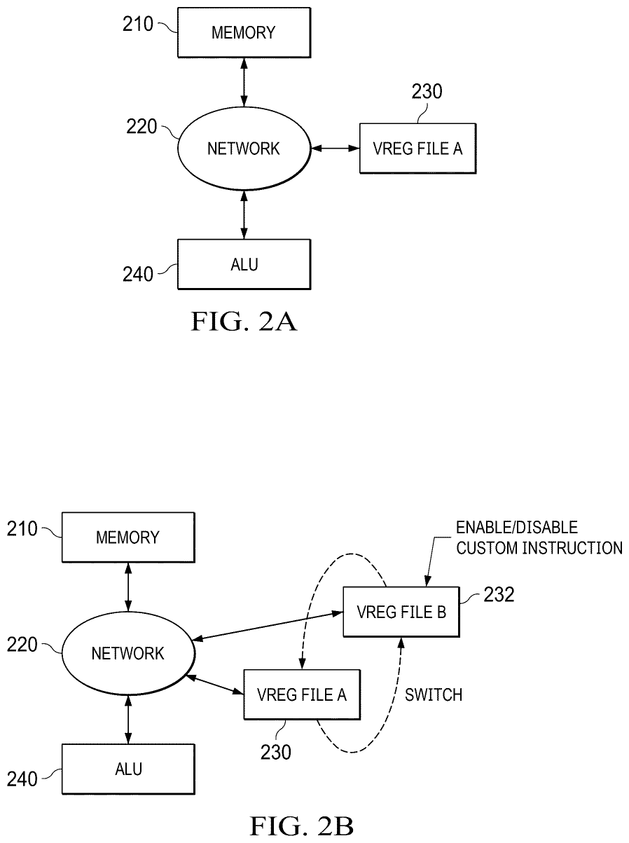

FIG. 2A shows a block diagram of a vector process base architecture. Memory 210 communicates with a network 220 via a register file 230. An ALU also communicates with the network 220. The network provides multiple input and output port cross-bar functionality that is provided with the register file that provides any register in a register file could be connected as input and output register as input and output operands of the ALU and likewise source and destination registers of the Memory Load and Store operations, respectively. The network 200 shown in FIG. 2A may be considered as the glue logic for the VRFs (and in fact can be considered as part of the VRF) so that any register in the VRF can source the input and output operands for the ALU.

FIG. 2B shows a block diagram of a vector process base architecture with a custom hardware enhancement including an additional register file 232. Memory 210 communicates with a network 220 via a register file 230. An ALU also communicates with the network 220. The additional instructions to be added may include: enable VREG FILE A, disable VREG FILE A, enable VREG FILE B, disable VREG FILE B, and switch. A loop may include: Load V1; Load V2; ALU operation; Store V3; Switch; B loop, and dis VREG FILE B. The system may switch between register file 230 and additional register file 232.

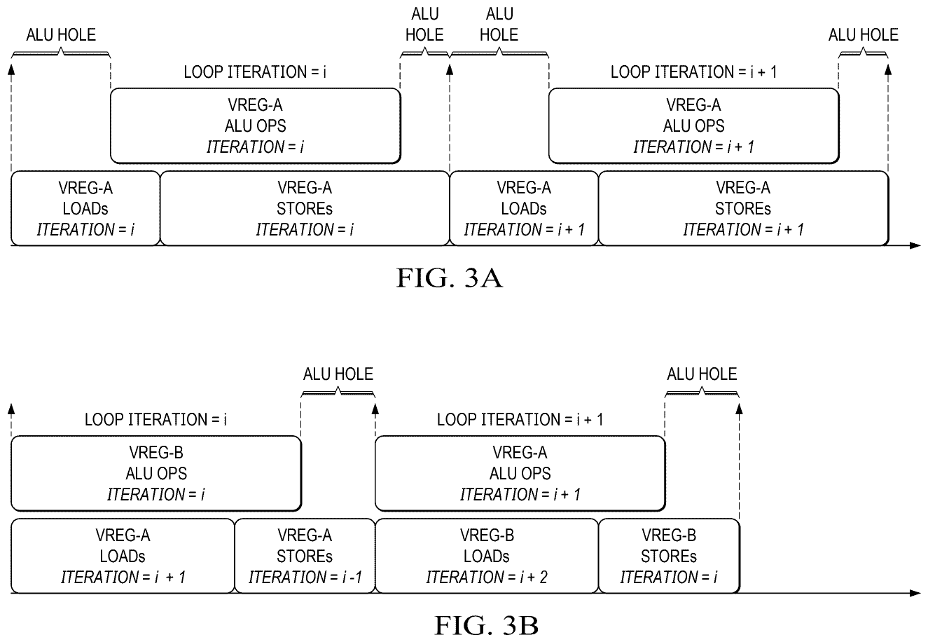

FIG. 3A shows a flow diagram to illustration of operation of a RISCV/SIMD-VP system using one vector register file. In particular, FIG. 3A illustrates loop iterations for the system illustrated in FIG. 2A. As shown in FIG. 3A, if custom instruction is disabled, it will be RISCV RVV compatible.

In Loop iteration=i, a vector register file (REG FILE VRFA) is enabled. Vector data for iteration=i is loaded from a memory into the vector register file (REG FILE VRFA). The system waits for data to load. An arithmetic logic unit (ALU) performs operation using the vector data from the first vector register file (REG FILE VRFA). A result for iteration=i of the ALU operation is stored in the vector register file (REG FILE VRFA). In Loop iteration=i+1, the vector register file (REG FILE VRFA) is enabled. Vector data for iteration=i+1 is loaded from a memory into the vector register file (REG FILE VRFA). The system waits for data to load. An arithmetic logic unit (ALU) performs operation using the vector data from the vector register file (REG FILE VRFA). A result for iteration=i+1 of the ALU operation is stored in the vector register file (REG FILE VRFA). As shown in FIG. 3A, the ALU waits for operands/data before starting operand computation such that there are “ALU holes” before and after the ALU operations.

FIG. 3B shows a flow diagram illustrating operation of a RISCV/SIMD-VP system using a vector register file (REG FILE VRFA) and an additional vector register file (REG FILE VRFB) for two consecutive loop iterations, i and i+1 (except i=1 and i=2 and i=Last-1 and i=Last). In particular, FIG. 3B illustrates loop iterations for the system illustrated in FIG. 2B. As shown in FIG. 3B, if custom instruction is enabled, one REG FILE VRFA provides Vector Registers for load/store to/from memory, and does not block ALU operations via REG FILE VRFB as operations are done on previous input data. In Loop iteration=i, both a first vector register file (REG FILE VRFA) and a second vector register file (REG FILE VRFB) are enabled. Vector data for iteration=i+1 is loaded from a memory into the first vector register file (REG FILE VRFA). An arithmetic logic unit (ALU) performs operation using the vector data from the second vector register file (REG FILE VRFB). As a result for loop iteration=i−1 of the ALU operation is already stored in the second vector register file (REG FILE VRFB), soon after the vector data is loaded from the memory, the vector processor may be able to store this result into memory without waiting for ALU operation. In Loop iteration=i+1, both a first vector register file (REG FILE VRFA) and a second vector register file (REG FILE VRFB) are enabled. Vector data for iteration=i+2 is loaded from a memory into the second vector register file (REG FILE VRFB). An arithmetic logic unit (ALU) performs operation using the vector data from the first vector register file (REG FILE VRFA). As a result for iteration=i of the ALU operation is already stored in the second vector register file (REG FILE VRFB) in previous loop iteration i, the vector processor may store this result into the memory without waiting for ALU operation to finish. In this way, for any loop iteration, dependency of the ALU operation on Memory Load, dependency of Memory Store on ALU operation and dependency of next loop iteration's memory load on completion of Memory store are delinked. As shown in FIG. 3B, the ALU does not wait for operands/data before starting operand computation such that there is a minimal “ALU hole” (i.e. minimum number of processor cycles depending on Store operation cycles) after the ALU operations. The cumulative duration of the ALU holes in FIG. 3B are shorter than the cumulative duration of the ALU holes in FIG. 3A.

Loop cycle time is max (Load/Store cycles, ALU Ops cycles). The loop cycle time shown in FIG. 3A is longer than the loop cycle time shown in FIG. 3B, because, for example, in loop iteration (i), the system shown in FIG. 3B does not wait to perform ALU operand operations in REG FILE VRFB while the system does load/store to/from memory in REG FILE VRFA. Because the ALU operation does not wait for input operands to start computation and memory does not wait for ALU operation to finish, the system may speed up RISCV/SIMD-VP as shown by the diagram of FIG. 3B having a lesser cycles/time than the diagram of FIG. 3A. Thus, with two vector registration files, the loop cycle time is reduced.

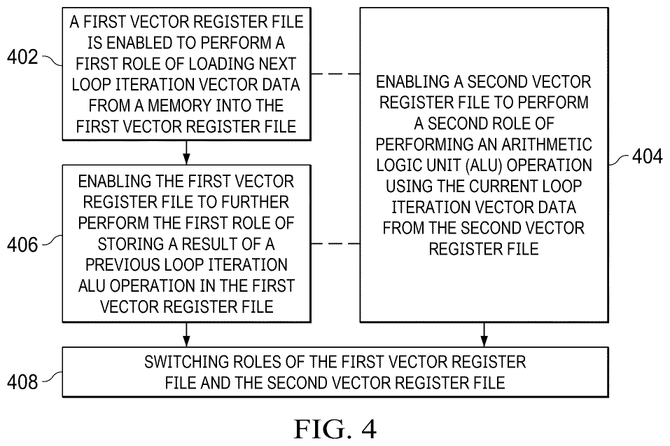

FIG. 4 shows a flow chart of a method for speeding up RISCV/SIMD-VP by overcoming data and operand dependence by adding an additional circuit for an additional Vector Register File (VRFA, VRFB). A first vector register file is enabled to perform a first role of loading 402 next loop iteration vector data from a memory into the first vector register file. A second vector register file is enabled to perform a second role of performing 404 an arithmetic logic unit (ALU) operation using the vector data from input and output operands as registers in the second vector register file. The first vector register file is enabled to further perform the first role of storing 406, a result of the ALU operation in the first vector register file from the previous loop iteration. The roles of the first vector register file and the second vector register file are switched 408.

In a first loop iteration (i), the first vector register file may be used to perform a load/store role and the second vector register may be used to perform an ALU operation role. In the load/store role, the first vector register file may have loaded therein first vector data from a memory for the next loop iteration (i+1). According to an ALU operation role, a second vector register may provide, with an arithmetic logic unit (ALU) operation, the input and output operand vector registers from the second vector register file that was loaded in previous loop iteration (i−1). Further in the load/store role, the first vector register file may store a result of the ALU operation in previous loop iteration (i−1). In a second loop iteration (i+1), the roles of the first vector register file and the second vector register file are switched. The first vector register file may provide input and output operand registers for ALU operation role and the second vector register may perform a load/store role. In the load/store role, the second vector register file may have loaded therein next loop iteration (i+2) input vector data from a memory. According to an ALU operation role, the first vector register file may provide an arithmetic logic unit (ALU) operation with input and output operand registers corresponding to the current loop iteration, (i+1). In the load/store role, the second vector register file may store a result of the ALU operation corresponding to previous loop iteration, (i). Thus, from the first loop iteration to the second loop iteration, the roles of the vector registers have switched.

Although examples have been described above, other variations and examples may be made from this disclosure without departing from the spirit and scope of these examples.

We claim:

1. A vector processor system, comprising:
a vector processor, in a loop iteration cycle, operable to:
enable a first vector register file to perform a first role of loading vector data of a subsequent loop iteration cycle from a memory into the first vector register file;
enable a second vector register file to perform a second role of providing input and output registers as operations for an arithmetic logic unit (ALU) operation using vector data of the current loop iteration cycle from the second vector register file;
enable the first vector register file to further perform the first role of storing a result of an ALU operation using vector data of a prior loop iteration cycle in the first vector register file; and
switch roles of the first vector register file and the second vector register file.

2. The vector processor system of claim 1, wherein the vector processor, in the subsequent loop iteration cycle, is further operable to:
enable the second vector register file to perform the first role of loading new vector data from the memory into the second vector register file while enabling the first vector register file to perform the second role of providing input and output registers as operands for a subsequent ALU operation using the vector data from the first vector register file.

3. The vector processor system of claim 2, wherein the vector processor, in the subsequent loop iteration cycle, is further operable to enable the second vector register file to further perform the first role of loading the next loop iteration's input operands using new vector data and storing a result of the previous ALU operation after switching roles of the first and second vector register files.

4. The vector processor system of claim 1, wherein switching roles of the first vector register file and the second vector register file comprises connecting the first vector register file to the memory and the second vector register file to an ALU.

5. The vector processor system of claim 4, wherein subsequently switching roles again further comprises:
disconnecting the first vector register file from the memory and disconnecting the second vector register file from the ALU; and
connecting the first vector register file to the ALU and the second vector register file to the memory.

6. The vector processor system of claim 1, wherein the processor is further operable to disable the second vector register file after completing a series of ALU operations over multiple loop iterations.

7. The vector processor system of claim 1, further comprising:
a state machine operable to control enabling, disabling, and switching of the first and second vector register files.

8. A method of operating a vector processor, comprising:
enabling a first vector register file to perform a first role of loading vector data from a memory into the first vector register file;
enabling a second vector register file to perform a second role of performing an arithmetic logic unit (ALU) operation using the vector data from the second vector register file;
enabling the first vector register file to further perform the first role of storing a result of the ALU operation in the first vector register file; and
switching roles of the first vector register file and the second vector register file.

9. The method of claim 8, further comprising enabling the second vector register to perform the first role of loading new vector data from the memory into the first vector register file and storing a result of an ALU result from the first register file, while enabling the second vector register file to perform the second role of providing input and output operand registers for the ALU operation.

10. The method of claim 9, further comprising enabling the second vector register file to further providing input and output registers for a subsequent ALU operation using the new vector data from the second vector register file and storing result of ALU operation respectively after switching roles of the first and second vector register files.

11. The method of claim 8, wherein switching roles of the first vector register file and the second vector register file comprises connecting the first vector register file to the memory and the second vector register file to the ALU.

12. The method of claim 11, wherein switching roles further comprises:
disconnecting the first vector register file from the memory and disconnecting the second vector register file from the ALU; and
connecting the first vector register file to the ALU and the second vector register file to the memory.

13. The method of claim 8, further comprising disabling the second vector register file after completing a series of ALU operations over multiple loop iterations.

14. The method of claim 8, further comprising controlling enabling, disabling, and switching of the first and second vector register files using a state machine.

15. A non-transitory computer-readable medium storing instructions that, when executed by a processor, cause the processor to perform operations comprising:
enabling a first vector register file and a second vector register file in a vector processor;
alternately using the first vector register file for memory operations and the second vector register file for arithmetic logic unit (ALU) operations; and
switching roles of the first vector register file and the second vector register file after completing a set of vector operations.

16. The non-transitory computer-readable medium of claim 15, wherein the operations further comprise loading vector data from a memory into the first vector register file while performing ALU operations using the second vector register file.

17. The non-transitory computer-readable medium of claim 15, wherein the operations further comprise storing results of the ALU operations in the first vector register file while performing an ALU operation using registers of the second vector register file as input and output operands.

18. The non-transitory computer-readable medium of claim 15, wherein switching roles of the first vector register file and the second vector register file comprises:
connecting the first vector register file to an arithmetic logic unit and the second vector register file to the memory.

19. The non-transitory computer-readable medium of claim 15, wherein subsequently again switching roles of the first vector register file and the second vector register file comprises:
disconnecting the first vector register file from the memory and disconnecting the second vector register file from the ALU; and
connecting the first vector register file to the ALU and the second vector register file to a memory.

20. The non-transitory computer-readable medium of claim 15, wherein the operations further comprise disabling the second vector register file after completing a series of vector operations over multiple loop iterations to return to a default configuration with only the first vector register file enabled.

21. The non-transitory computer-readable medium of claim 15, wherein the instructions that, when executed by a processor, cause the processor to perform operations comprising copying persistent vector data stored in a vector register from a current ALU-connected vector register file to a corresponding vector register in the memory-connected vector register file.
